(19) United States
(12) Patent Application Publication
(10) Pub. No.: US 2019/0169899 A1
(43) Pub. Date: Jun. 6, 2019

(54) SLIDING DOOR PARTITION WALL SYSTEM

(71) Applicant: INTERNATIONAL OFFICE CONCEPT S.P.A., Giussano (Monza Brianz) (IT)

(72) Inventor: KRZYSZTOF MIKSZA, Milano (IT)

(21) Appl. No.: 16/210,910

(22) Filed: Dec. 5, 2018

(30) Foreign Application Priority Data
Dec. 6, 2017 (IT) 102017000140813

(51) Int. Cl. E05D 15/08; E06B 3/46; E05F 11/54

(52) U.S. Cl. CPC E05D 15/08; E06B 3/4636; E05Y 2900/132; E05Y 2900/142; E05F 11/54

(57) ABSTRACT

A sliding door partition wall system, comprising: a plurality of mobile doors (2) telescopically between an opening condition in which they are mutually overlapped and arranged near a reference wall (6) and an opening condition in which they extend along a movement direction (A); at least one fixed door (3), stably arranged near the reference wall (6) and on which the mobile doors (2) overlap in the respective opening condition; said doors (2, 3) having respective peripheral frames (4); and a positioning element (9) of the mobile doors (2), configured to constraint each mobile door (2) along a direction (B) perpendicular to the movement direction (A), and to define an alignment condition of the frames (4) of the mobile doors (2) to the frame (4) of the fixed door (3) in said opening condition.

The present invention relates to a sliding door partition wall system. In particular, the present invention relates to a system which can be applied to the sliding doors mutually coupled telescopically to be moved in respective closing/opening conditions and along a respective movement direction.

As known, the partition walls generally consist of at least one door manually sliding between the opening position in which it is overlapped on a respective fixed door (or other fixed structure such as a wall), and a closing position in which it is completely extended with respect to the fixed door to occlude a passage.

In the case of a plurality of mobile doors, for example three mobile doors, the same can be simultaneously moved between the respective opening and/or closing positions by means of suitable motion transmission members.

In this situation, from the opening condition in which the mobile doors are mutually overlapped on each other and to the fixed door, the movement of the mobile door distal to the fixed door causes the simultaneous sliding of all the doors which in series are forced to slide up to the closing condition in which they are all extended (not overlapping).

The simultaneous movement of the mobile doors takes place by means of the transmission members arranged at the upper cross member of the individual frames defining the respective doors.

These members generally consist of a preferably toothed belt system, operatively connected to a series of pulleys arranged at the two ends of each door.

In particular, the mobile doors comprised between the fixed door and the door distal to the fixed door, present a pair of pulleys at the upper cross-member arranged outside the footprint of the same cross member and respectively at the front and rear of the frame.

In the exemplary case of a wall consisting of a fixed door (or another fixed structure) and three movable doors, only the two doors interposed between the fixed door and the door distal to the fixed door (the outer door) have the aforementioned pulleys for the sliding of the belt that connects the mobile doors to each other.

Therefore, when the outer door is moved, the belt moves the individual doors to respective different speeds according to the pulley/belt sizing.

The doors are also provided with suitable guiding systems, mostly consisting of carriages placed above and below the respective frames.

In particular, the upper carriage is associated with the upper cross member of the mobile door and has rollers sliding in a groove formed inside a section bar.

Similarly, the lower carriages are associated with the lower cross member of each moving door and generally have a sliding or rolling guide housed in a groove formed in a respective base.

In accordance with the mostly diffused known technique, the guide is made in the form of a runner extending from the lower cross member and inside the guide. The runner is made of self-lubricating material to facilitate the sliding of the same with the opposite walls of the guide defining the groove for housing the runner.

Guides may also be provided consisting of a rolling roller adapted to rotate in two different directions according to the movement of the door (in opening or closing) and according to the wall of the guide on which the roller itself rolls.

However, these solutions have the drawback of allowing a tilting movement of the mobile doors which, constrained on the upper part, sway along a direction perpendicular to the movement direction, allowing the runner/roller to slide on one of the two walls of the guide facing each other. This oscillation, even if minimal, determines the vibration of the door in the sliding phase with the consequent drawbacks in terms of noise and discontinuity of the movement itself.

To eliminate the oscillation of the doors, pairs of rollers can be arranged near each other and each sliding on a respective wall of the guide.

However, this solution proves to be difficult to implement because it implies an excessive cross-dimensioning of the individual doors with the consequent spacing of the doors between each other.

In this situation, in fact, the two rollers arranged near would need to slide inside a very wide guide in the direction transverse to the respective longitudinal development.

In this context, especially in the opening condition of the doors that are overlapped between each other, there is a very high footprint of the entire wall caused by excessive mutual spacing of the doors.

The drawback deriving from the excessive footprint of the entire wall proves to be decisive not only in terms of distance between the doors, but also in terms of volumes of the support frame of each single door.

In fact, in order to house the pulleys in the total footprint of the doors in the respective open condition (overlapping doors), vertical uprights of very high thickness are provided, to obtain the alignment of the same uprights avoiding the shifting of the mobile doors from the fixed one.

In other words, the presence of the pulleys outside the lateral footprint of the frame and in particular in a rear position with respect to the closing direction of the doors, requires to keep the doors to be spaced apart from the end-of-stroke wall (supporting wall of the fixed door).

This spacing therefore determines an offset of the mobile doors compared to the fixed one which, in the opening condition of the doors, appears to be unsightly and inefficient.

This drawback is even more decisive in the case of glass doors which therefore have a rectangular frame with a frame and a central transparent area. In this case, in fact, the transparency of the central area emphasizes the non-alignment condition of the doors.

To overcome this situation, the vertical uprights are thus sufficiently thick enough to define a perfect alignment of all the doors.

However, as specified above, this solution is not free from drawbacks, since the thickening of the vertical uprights entails a greater footprint of the entire structure with the consequent disadvantages in terms of structural complexity, construction costs and weight of the structure itself.

Moreover, in the above described case of the glass doors, the presence of a very visible frame is particularly unsightly, rendering the effect of transparency and “cleaning” typical of the glass walls ineffective, especially in the closed position in which the vertical uprights are spaced along the entire zone covered by the doors.

In this context, the technical task underlying the present invention is to propose a sliding door partition wall system that overcomes the drawbacks of the prior art mentioned above.

In particular, it is a main object of the present invention to provide a partition wall system that is able to contain the overall footprints of the doors while ensuring the correct operation of the opening and closing operations of the mobile doors.

In greater detail, an object of the present invention is to provide a system for a partition wall able to limit the distance of the doors in the condition of mutual overlapping and able to consistently limit the dimensions of the frame provided for each door.

A further object of the present invention is that of proposing a system capable of eliminating any oscillations of the mobile doors, thus making the movement of the doors silent, fluid and continuous.

Finally, a further object of the present invention is to provide a system which is able to limit the thicknesses of the vertical uprights to make them perfectly alignable and of limited thickness to give a pleasing aesthetic effect both in the opening and closing condition.

The technical task mentioned and the objects stated are substantially achieved by a sliding door partition wall system, comprising the technical characteristics set out in one or more of the appended claims.

Further characteristics and advantages of the present invention will become more apparent from the description of an exemplary, but not exclusive, and therefore non-limiting preferred embodiment of a sliding door partition wall system, as illustrated in the appended drawings, wherein:

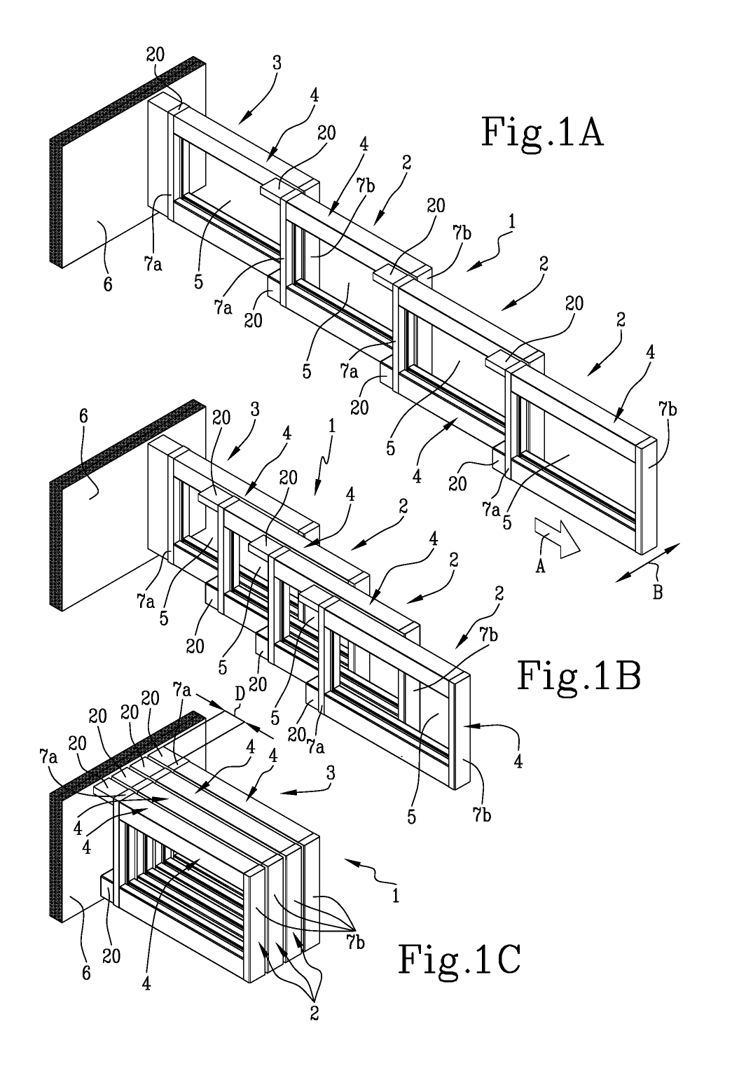

FIGS. 1a, 1b and 1c show perspective and schematic views of a sliding door partition wall system according to the present invention in respective operating conditions;

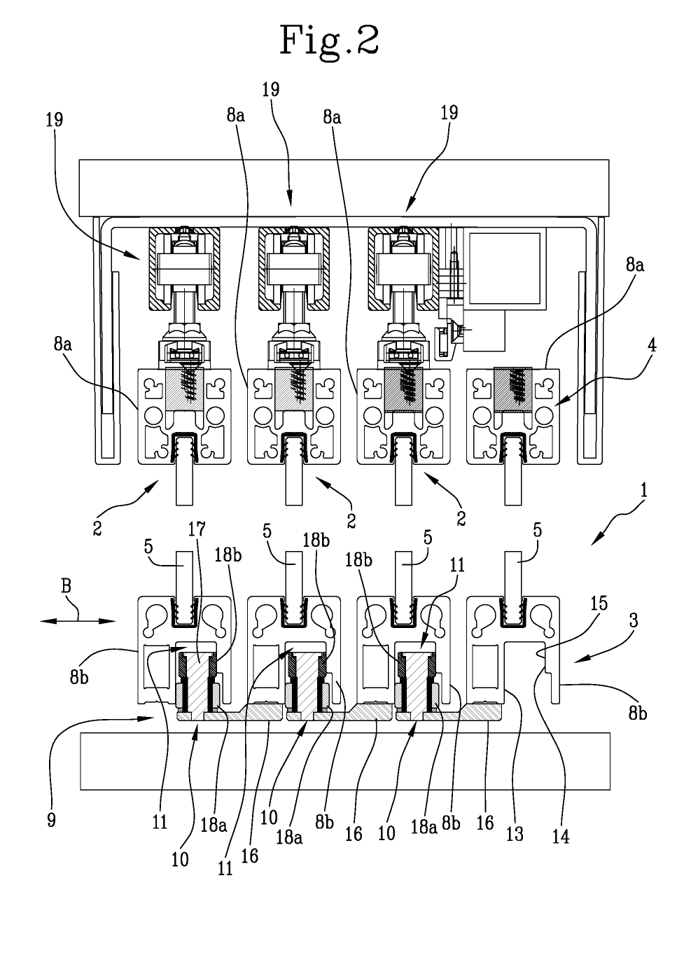

FIG. 2 shows a cross-sectional and schematic view of the partition wall system, in a respective open condition;

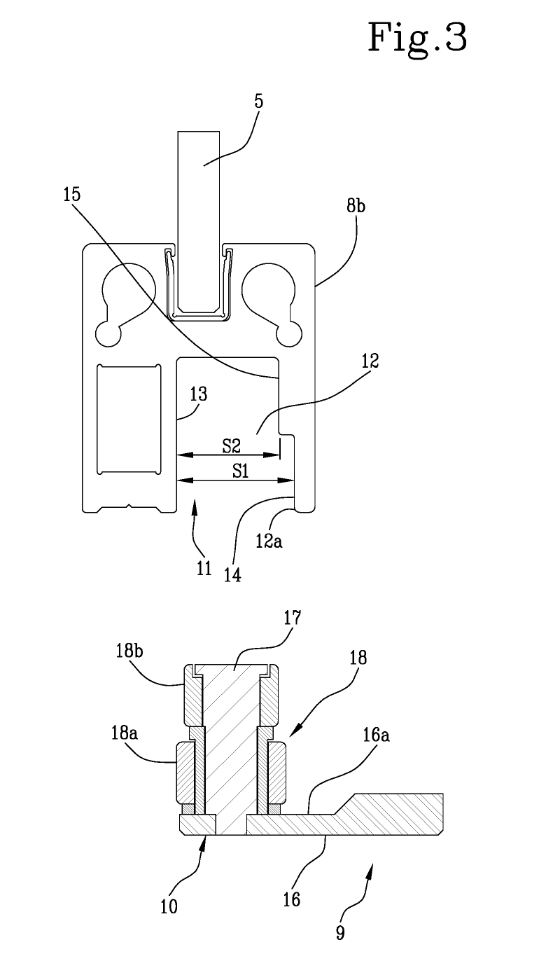

FIG. 3 shows a sectional and exploded constructive detail of the system of FIG. 2;

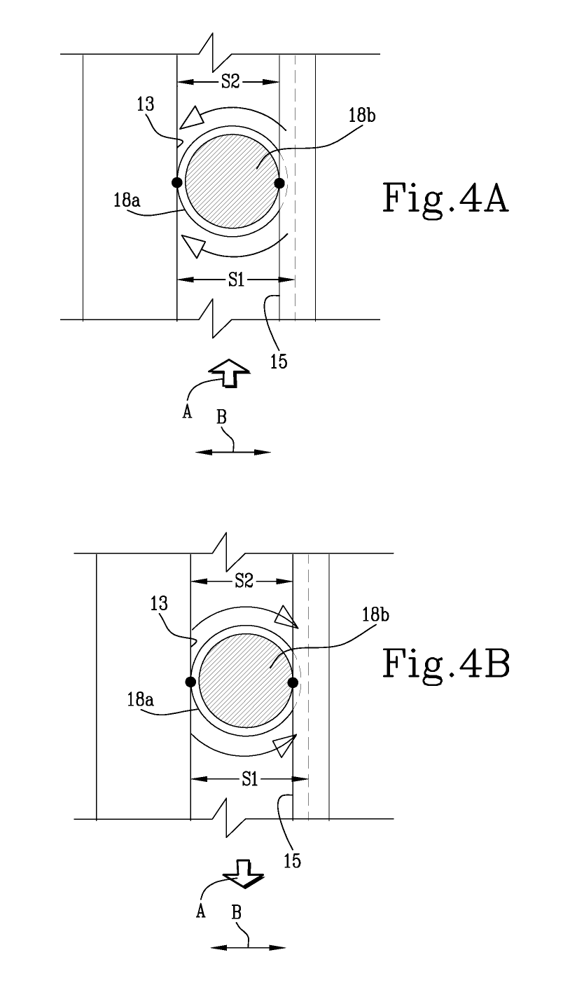

FIGS. 4a and 4b show schematic plan views from above of the constructive detail of FIG. 3 in two respective operating conditions;

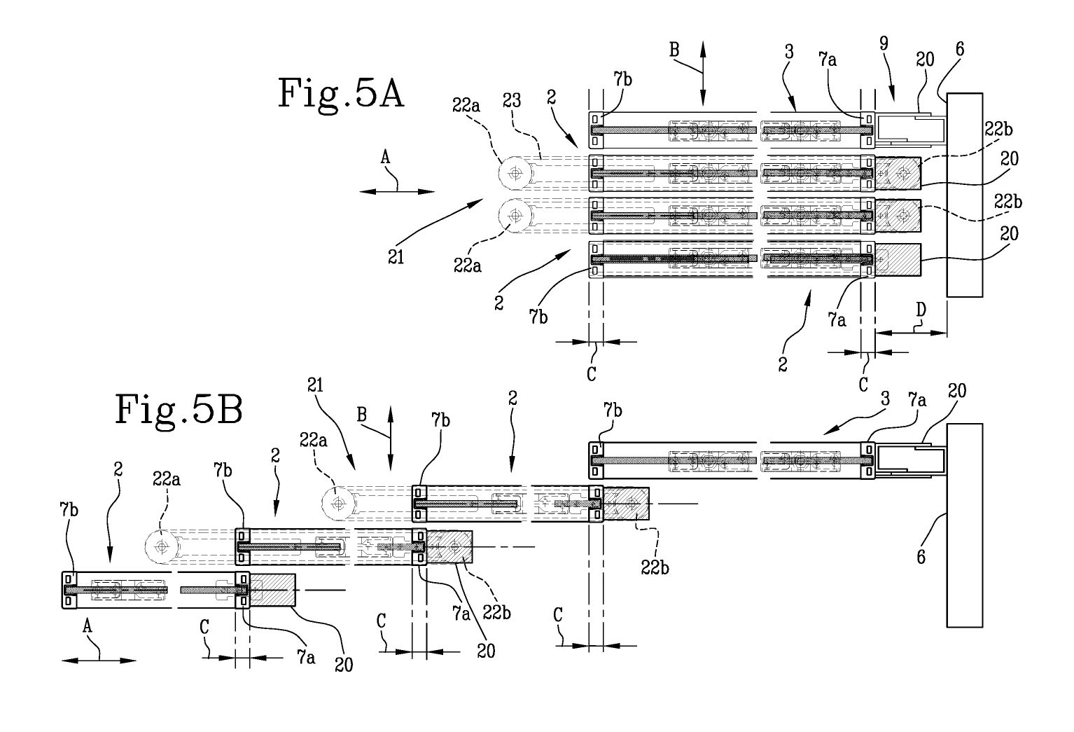

FIGS. 5a and 5b show a schematic plan view from above and in section of the partition wall system in respective opening and closing conditions; and

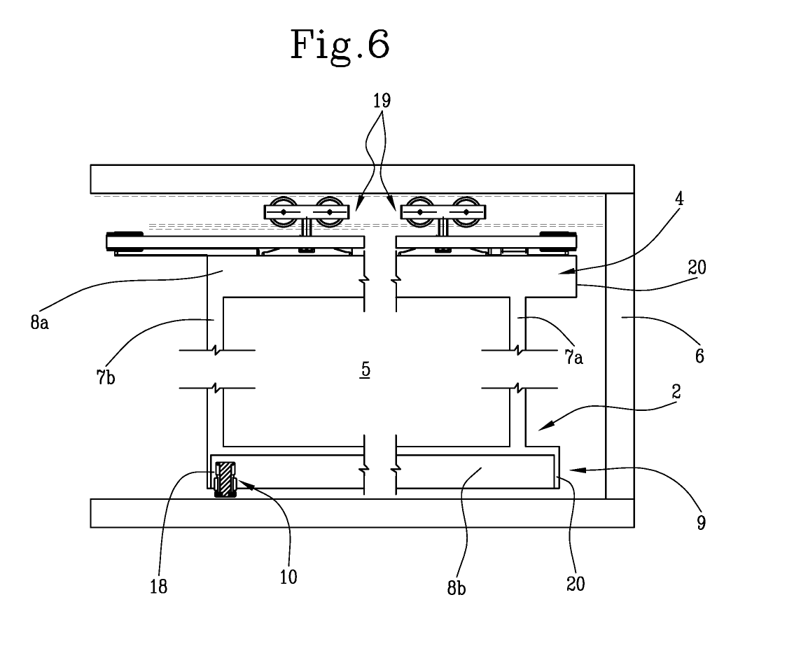

FIG. 6 shows a schematic front view, with some parts removed to better illustrate others, of a sliding door of the partition wall system in accordance with the present invention.

As illustrated in the accompanying figures, the reference numeral 1 globally indicates a sliding door partition wall system according to the present invention.

It should be specified that the present invention can be applied to partition walls with sliding doors of any type, which are telescopically associated and movable along a movement direction.

Advantageously, the invention finds particular application in the partition walls provided with a number of doors greater than two, configured to move simultaneously between a closing/opening condition.

Furthermore, the Applicant has found that the present invention finds greater advantages for sliding doors made of glass and provided with a peripheral support frame.

For this reason, in the continuation of the present discussion reference will be made, purely by way of example, and therefore non-limiting, to a partition wall system 1 provided with three mobile doors 2 and a fixed door 3, in which each door 2, 3 has a supporting frame 4 adapted to contain a transparent central panel 5, preferably made of glass.

In more detail, the mobile doors 2 are mutually coupled telescopically between an opening condition (FIG. 1c) in which they are mutually overlapped and arranged near a reference wall 6 and a closing condition (FIG. 1a) in which they extend along a movement direction “A”. FIG. 1b shows an intermediate condition in which the mobile doors 2 are moved along the aforementioned direction “A”.

More particularly, the fixed door 3 is stably arranged near to the reference wall 6 and extends along a plane perpendicular to the lying plane of the wall 6. As illustrated in FIGS. 1c, 2 and 5a, the mobile doors 2 in the respective opening condition are mutually overlapped on the fixed door 3. All doors 2, 3 have the same shape, size and aesthetic effect. For this purpose, each door 2, 3 is provided with a peripheral frame 4 having substantially rectangular configuration and defining a frame of the glass panel 5.

The frame 4 can be made of any material, such as metal material, and has two vertical uprights 7a, 7b parallel to each other and suitably spaced from an upper horizontal cross member 8a and a lower horizontal cross member 8b (FIG. 6).

Each upright 7a, 7b and cross member 8a, 8b is preferably constituted in the form of a section bar having a substantially straight configuration.

It should also be noted that a first vertical upright 7a is near to the wall 6 and a second vertical upright 7b is distal from said wall 6. In this situation, the first vertical upright 7a of the fixed door 3 is stably engaged to the wall 6.

The system 1 further comprises a positioning element 9 of the mobile doors 2, configured to constraint each mobile door 2 along a direction “B” perpendicular to the movement direction “A”, and to define an alignment condition of the frames 4 of the mobile doors 2 to the frame 4 of the fixed door 3 in the opening condition.

In particular, according to a first aspect of the invention, the positioning element 9 of the mobile doors 2 comprises at least one lower carriage 10 for each mobile door 2, sliding by rolling friction in a respective guide 11 extending along the movement direction “A”.

Advantageously, the aforesaid guide 11 is defined in the lower cross member 8b of each mobile door 2 (FIG. 2).

In greater detail, the lower cross member 8b is profiled with a longitudinal groove 12 which defines the guide 11. The groove 12 has an access opening 12a of the lower carriage 10 facing downwards (on the opposite side with respect to the panel 5) and a pair of side walls 13, 14 facing each other and spaced apart to define a containment section of the lower carriage 10.

As better illustrated in FIG. 3, the containment section has a first area S1 having a greater width proximal to the access opening 12a and a second area S2 having a smaller width with respect to the first area S1, and distal to the aforesaid opening 12a.

In this situation, the guide 11 has a variable section defined by a first flat side wall 13 and a second side wall 14 provided with a cantilever 15.

In particular, always referring to FIG. 3, it should be noted that the second side wall 14 has the cantilever 15 at the second area S2 which extends towards the first side wall 13. In this way, a “step” is defined on the second wall 14 which determines the narrowing of the passage section of the guide 11 at the aforementioned second area S2.

The lower carriage 10 comprises a base portion 16 having a surface 16a facing the groove 12, and a rotation pin 17 emerging from the surface 16a and extending into the groove 12.

In particular, the base portion 16 is constituted by a substantially flat bar engaged to the lower cross member 8b of the door 2, 3 adjacent to that in which the respective pin 17 is housed.

In other words, with reference to FIG. 2, each door 2, 3 with the exception of the movable door 2 furthest from the fixed door 3, presents the base portion 16 engaged to the respective cross member 8b and extending under the cross member 8b of the adjacent door 2.

The carriage 10 further comprises rolling means 18 operatively associated with the pin 17 to slide on at least one wall 13, 14 of the guide 11.

In particular, the rolling means 18 comprising a first roller 18a mounted idle on the pin 17 and arranged in the first area S1 and a second roller 18b mounted idle on the pin 17 and arranged in the second area S2.

The rollers 18a, 18b are mounted overlapped on the pin 17 and independent with respect to each other to be able to individually roll on the pin 17.

In this situation, with reference to FIG. 2 and to FIGS. 4a and 4b, the first roller 18a is slidingly associated with the first side wall 13 and spaced apart from the second side wall 14. Similarly, the second roller 18b is slidingly associated with the second side wall 14 and spaced apart from the first wall 13.

Moreover, the first roller 18a has a larger diameter than the second roller 18b, as shown by the schematic views of FIGS. 4a and 4b.

Advantageously, this difference in diameter allows the rollers 18a and 18b to each be abutted to a respective wall 13, 14, thus ensuring continuous contact with the wall itself.

The second roller 18b with a smaller diameter is abutted to the cantilever 15 of the second wall 14 to roll in both directions always resting on such cantilever 15 and at the same time the first roller 18a of greater diameter is abutted to the first wall 13 to roll in the two directions always resting on such first wall 13.

The carriage is located at one end of the respective lower cross member 8b.

Furthermore, in order to facilitate the movement of the mobile doors 2 along the direction “A”, upper carriages 19 slidingly associated with respective upper guides formed in the cross member of the fixed structure of the door are also provided.

The upper carriages 19 can be of any type and are not described and illustrated in detail since they are of a known type.

According to another aspect of the invention, the system 1 can be provided of connection means 21 for the movement of the mobile doors 2 to simultaneously move the same mobile doors 2 between the respective opening/closing conditions.

As better described in the following, the connection means 21 extend at least partially over the width of the mobile doors 2 defined between the vertical uprights 7a, 7b of each frame 4.

In this case, the positioning element 9 of the mobile doors 2 further comprises a spacer element 20, extending at least from the fixed door 3 and interposed between the frame 4 of the fixed door 3 and the reference wall 6.

Advantageously, the spacer element 20, which can be provided for all the doors 2, 3, defines an end-of-stroke position of the mobile doors 2 in the respective opening conditions (FIGS. 1c and 5a) in which the respective frames 4 are spaced apart from the reference wall 6 of a gap “D” defined by the length of the element 20.

Preferably, the spacer element 20 of the mobile doors can be slightly spaced apart from the wall 6 and extend inside the aforementioned gap “D”. In any case, for each door 2, 3 a spacer element 20 is preferably provided, constituting a projection of the upper cross member 8a and lower cross member 8b which extends beyond the first upright 7a towards the wall 6.

In this situation, the connection means 21 are contained, in the opening condition (FIG. 5a), at least partially in the gap “D” defined by the spacer element 20.

In greater detail, the connection means 21 consist of at least one front pulley 22a and a rear pulley 22b, placed at the sides of the mobile door 2 with respect to the movement direction “A”.

In other words, as is better highlighted in FIGS. 5a, 5b and 6, the pulleys 22a, 22b are arranged outside the width of the frame 4 defined between the vertical uprights 7a, 7b.

In this context, the rear pulley 22b is arranged in said gap “D”, defined by the spacer element 20 in the opening condition of the mobile doors 2.

The means 21 also have a belt 23, preferably toothed, operatively wound around the pulleys 22a, 22b.

Advantageously, according to the embodiment illustrated in the accompanying figures, the mobile doors 2 with the exception of the mobile door 2 distal from the fixed door 3 (the most external door) have the aforementioned pulleys 22a, 22b and a belt 23 which engages the pulleys to transmit the movement to all the doors 2.

In this way, by acting manually on the outermost mobile door 2 to slide the same along the direction “A”, the motion is transmitted to the other mobile doors 2 causing them to slide in the respective opening/closing condition.

The rear pulleys 22b of the respective doors 2 are all arranged in the gap “D” in the respective opening condition.

This entails the perfect alignment of the vertical uprights 7a and 7b both in the opening condition (FIGS. 1c and 5a) and in the closing condition (FIGS. 1a and 5b).

It should be noted, in fact, that the gap “D” defined by the spacer elements 20 allows the rear pulley 22b to be contained in the overall footprint when the doors 2 are opening condition, thus allowing the vertical uprights 7a, 7b of all the frames 4 to be aligned. Similarly, even in the closing condition, the uprights 7a, 7b are aligned with each other.

Advantageously, the possibility of keeping the rear pulley 22b outside the overall footprint defined between the uprights 7a, 7b further allows to maintain very reduced thicknesses “C” of the same uprights.

Preferably, the vertical uprights 7a and 7b of all the doors 2, 3 can therefore have a thickness “C” ranging from 16 mm to 20 mm, preferably equal to about 18 mm.

The thickness “C” thus corresponds to a very small value of alignment or overlapping of the uprights in the respective closing and opening conditions.

In other words, the spacer element 20 allows to significantly reduce the thickness of the vertical uprights, obtaining a perfect and minimal alignment in order to provide a greater aesthetic value to the entire sliding wall.

Moreover, the spacer element 20 arranged as an extension of the lower cross member 8b also allows to house, in the respective closed condition, the lower carriage 10 of the adjacent door outside the lateral footprint of the doors between the uprights 7a, 7b.

In this situation, the mobile doors 2 are more stable and better supported in their movement along the direction “A”.

It should also be considered that the carriages 10 allow, as specified above, to obtain a more fluid and guided movement, eliminating every vibration and noise of the movable door 2 during its movement.

This advantage is given by the presence of the two overlapping rollers 18a, 18b and provided with a differentiated diameter for sliding on respective opposite walls 13, 14 of the guide 11.

Therefore, a continuous contact and a stable support of the mobile doors 2 is ensured, further allowing to considerably reduce the volumetric footprints defined by the thickness of the cross members 8a and 8b.

In other words, the arrangement of the rollers 18a, 18b, and therefore the shape of the guide 11, allows the doors 2, 3 to be brought closer together, defining a very compact configuration with reduced footprints in the opening condition (overlapping doors).

1. A sliding door partition wall system, comprising:
a plurality of telescopically mobile doors (2) between an opening condition in which they are mutually overlapped and arranged near a reference wall (6) and an opening condition in which they extend along a movement direction (A);
at least one fixed door (3), stably arranged near the wall of reference (6) and on which the mobile doors (2) overlap in the respective opening condition;
said doors (2, 3) having respective peripheral frames (4);
characterised in that it further comprises a positioning element (9) of the mobile doors (2), configured to constrain each mobile door (2) along a direction (B) perpendicular to the movement direction (A), and to define an alignment condition of the frames (4) of the mobile doors (2) to the frame (4) of the fixed door (3) in said opening condition.

2. A system according to claim 1, characterised in that said positioning element (9) of the mobile doors (2) comprises for each mobile door (2) at least one lower carriage (10) sliding by rolling friction on a respective guide (11) extending along the movement direction (A); said frame (4) of each mobile door (2) having a lower horizontal cross member (8b) defining said guide (11).

3. A system according to claim 2, characterised in that said lower carriage (10) comprises:
a base portion (16) having a surface (16a) facing said guide (11);
a rotation pin (17) emerging from said surface (16a) and extending within the guide (11); and
rolling means (18) operatively associated with the pin (17) to slide on at least one wall (13, 14) of said guide (11).

4. A system according to claim 3, characterised in that said guide (11) comprises a longitudinal groove (12) formed on said lower cross member (8b) and defining an access opening (12a) of the pin (17) facing downwards and a pair of side walls (13, 14) facing each other and spaced apart from each other to define a containment section of the pin (17) of variable size.

5. A system according to claim 4, characterised in that said containment section has a larger first area (S1) next to the base portion (16) and a narrower second area (S2) distal from said base portion (16); said rolling means (18) comprising a first roller (18a) mounted idle on the pin (17) and arranged in said first area (S1), and a second roller (18b) mounted idle on the pin (17) and arranged in said second area (S2).

6. A system according to claim 5, characterised in that said first roller (18a) is slidingly associated to a first wall (13) of said side walls and spaced apart from the second side wall (14) to rotate around the pin (17), and in that said second roller (18b) is slidingly associated to the second side wall (14) and spaced apart from the first wall (13) to rotate around the pin (17).

7. A system according to claim 6, characterised in that said second wall (14) comprises a cantilever (15) at said second area (S2), said second roller (18b) sliding on said cantilever (15).

8. A system according to claim 5, characterised in that said first roller (18a) has a diameter larger than that of the second roller (18b); said rollers (18a, 18b) being mutually overlapped on said pin (17).

9. A system according to claim 3, characterised in that each base portion (16) is engaged to the lower cross member (8b) of the door (2) adjacent to the one in which the respective pin is housed (17).

10. A system according to claim 1, characterised in that it further comprises connection means (21) for moving the mobile doors (2) to move simultaneously the mobile doors (2) between the respective opening/closing conditions; said positioning element (9) of the mobile doors (2) comprising a spacer element (20) extending at least from said fixed door (3) and interposed between the frame (4) of the fixed door (3) itself and the reference wall (6).

11. A system according to claim 10, characterised in that said spacer element (20) defines an end-of-stroke position of said mobile doors (2) in the respective opening conditions, in which they are distanced from said reference wall (6) with a gap (D) defined by the length of said element (20).

12. A system according to claim 11, characterised in that said connection means (21) extend at least partially beyond the width of the mobile doors (2) defined between the respective uprights (7a, 7b) of each frame (4); said connection means (21) being contained, in the opening condition, at least partially in said gap (D) defined by the spacer element (20).

13. A system according to claim 12, characterised in that said connection means (21) comprise at least a front pulley (22a) and a rear pulley (22b), placed on the sides of the door (2) with respect to the movement direction (A), and a belt (23) operatively engaged to said pulleys (22s, 22b); said rear pulley (22b) being disposed in said gap (D), defined by the spacer element (20) in the opening condition of the mobile doors (2).

14. A system according to claim 13, characterised in that said connection means (21) comprise a plurality of front (22a) and rear pulleys (22b) associated to the respective mobile doors (2), and a belt (23) which connects said pulleys (22a, 22b) to each other; said rear pulleys (22b) being all disposed in said gap (D), defined by the spacer element (20) in the opening condition of the mobile doors (2).

15. A system according to claim 10, characterised in that each frame (4) has a first vertical upright (7a), near the reference wall (6), and a second vertical upright (7b), distal from said reference wall (6); said uprights (7a, 7b) being mutually aligned in said opening condition and said closing condition.

16. A system according to claim 10, characterised in that said vertical uprights (7a, 7b) of the doors (2, 3) have a thickness (C) in the range from 16 mm to 20 mm; said thickness (C) defining an alignment value between the uprights in the respective closing and opening conditions.
